(19) United States
(12) Patent Application Publication
(10) Pub. No.: US 2014/0051530 A1
(43) Pub. Date: Feb. 20, 2014

(54) GOLF BALL WITH RADIALLY COMPRESSED INTERMEDIATE LAYER

(71) Applicant: NIKE, Inc., Beaverton, OR (US)

(72) Inventors: Aaron Bender, Portland, OR (US); Arthur Molinari, Portland, OR (US); Derek A. Fitchett, Beaverton, OR (US); John Chen, Hockessin, DE (US); Chen-Tai Liu, Yun-lin Hsien (TW)

(73) Assignee: NIKE, Inc., Beaverton, OR (US)

(21) Appl. No.: 14/067,095

(22) Filed: Oct. 30, 2013

Related U.S. Application Data
(63) Continuation-in-part of application No. 12/822,449, filed on Jun. 24, 2010.

(51) Int. Cl. B29D 99/00; A63B 37/00

(52) U.S. Cl. CPC B29D 99/0042; A63B 37/0046; A63B 37/0039; A63B 37/0052
USPC 473/354; 473/370; 473/363; 264/255

(57) ABSTRACT

A method of forming a golf ball includes molding a golf ball core through at least one of injection molding and compression molding, and subsequently volumetrically contracting the core. Once the core is contracted, an intermediate layer is formed about the core, and the core is subsequently allowed to expand to an intermediate state such that the core applies a contact pressure against an inner surface of the intermediate layer.

### CROSS REFERENCE TO RELATED APPLICATIONS

This application is a continuation-in-part of and claims the benefit of priority from U.S. patent application Ser. No. 12/822,449, filed Jun. 24, 2010, which is hereby incorporated by reference in its entirety.

### TECHNICAL FIELD

The present invention relates generally to a golf ball that includes a radially compressed intermediate layer surrounding a core.

### BACKGROUND

The game of golf is an increasingly popular sport at both the amateur and professional levels. To account for the wide variety of play styles and abilities, it is desirable to produce golf balls having different play characteristics.

Attempts have been made to balance a soft feel with good resilience in a multi-layer golf ball by giving the ball a hardness distribution across its respective layers (core, intermediate layer and cover) in such a way as to retain both properties. A harder golf ball may generally achieve greater distances, but less spin, and so will be better for drives but more difficult to control on shorter shots. On the other hand, a softer ball may generally experience more spin, thus being easier to control, but will lack distance. Additionally, certain design characteristics may affect the “feel” of the ball when hit, as well as the durability of the ball.

### SUMMARY

A method of forming a golf ball includes forming a golf ball core through at least one of injection molding and compression molding, and subsequently volumetrically contracting the core. Once the core is contracted, an intermediate layer is formed about the core, and the core is subsequently allowed to expand to an intermediate state such that the core applies a contact pressure against an inner surface of the intermediate layer.

In general, the resultant golf ball includes a golf ball core, an intermediate layer disposed about the golf ball core, and a cover disposed about the intermediate layer. A positive contact pressure exists between an inner surface of the intermediate layer and an outer surface of the golf ball core. Additionally, a radially compressive stress and a tangential hoop stress both exist across the entire intermediate layer and/or the core following the molding of the cover.

The contact pressure applied against the intermediate layer may radially compress that layer, and may allow impact stresses imparted by a golf club to more efficiently propagate throughout the ball.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of a multi-layer golf ball.

FIG. 2 is a schematic partial cross-sectional side view of an impact between a golf club and a golf ball.

FIG. 3A is a schematic cross-sectional view of a pair of injection molding dies for forming a core of a golf ball.

FIG. 3B is a schematic cross-sectional view of a pair of injection molding dies having a core of a golf ball formed therein.

FIG. 4A is a schematic cross-sectional view of piece of rubber stock.

FIG. 4B is a schematic cross-sectional view of an intermediate layer cold-formed blank.

FIG. 4C is a schematic cross-sectional view of a pair of compression molding dies being used to form a pair of cold-formed blanks about a metallic spherical core.

FIG. 4D is a schematic cross-sectional view of a pair of compression molding dies being used to compression mold an intermediate layer of a golf ball about a core.

FIG. 5 is a schematic cross-sectional view of an inner golf ball portion compressed by a compression layer.

FIG. 6A is a schematic cross-sectional view of an inner golf ball portion including a reactant disposed in an inner portion of the core.

FIG. 6B is a schematic cross-sectional view of the inner golf ball portion of FIG. 6A, with the reactant converted into a pressurized gas.

FIG. 7A is a schematic cross-sectional view of a contracted core of a golf ball.

FIG. 7B is a schematic cross-sectional view of an inner golf ball portion having an intermediate layer molded about the compressed core of FIG. 7A.

FIG. 7C is a schematic cross-sectional view of the inner golf ball portion of FIG. 5B, with the core having expanded to an intermediate state of compression.

FIG. 8 is a schematic free-body diagram of a portion of the intermediate layer of FIG. 6B and/or FIG. 7C.

FIG. 9 is a schematic free-body diagram of a portion of the intermediate layer of FIG. 5

### DETAILED DESCRIPTION

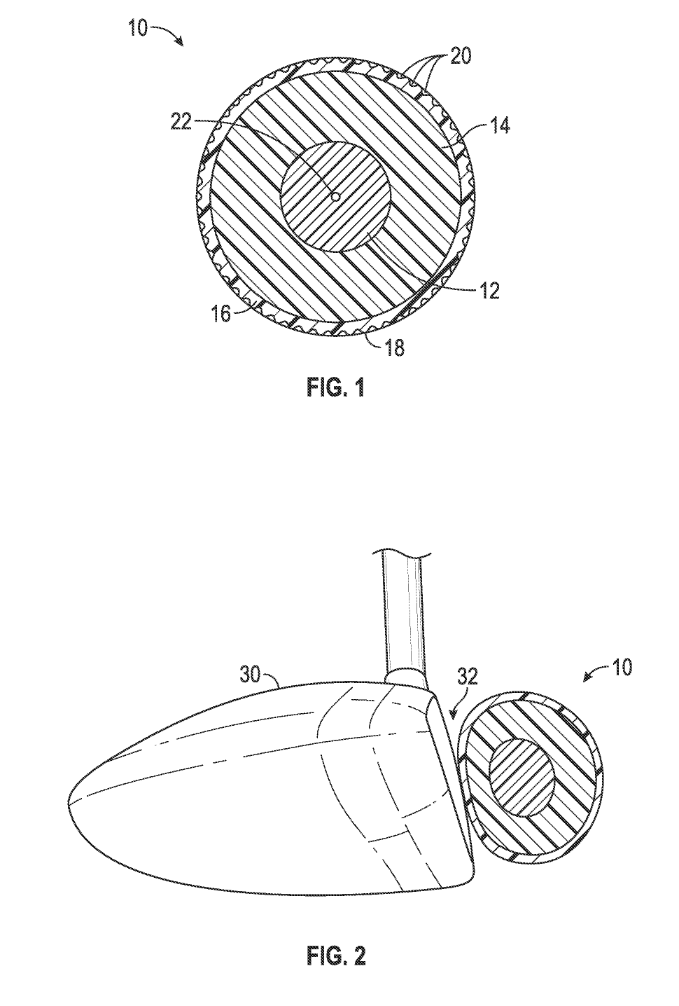

Referring to the drawings, wherein like reference numerals are used to identify like or identical components in the various views, FIG. 1 illustrates a schematic cross-sectional view of a golf ball 10. In the embodiment shown, the golf ball 10 has a three-piece construction that includes a core 12, an intermediate layer 14 surrounding the core 12, and a cover 16 surrounding the intermediate layer 14. The cover 16 defines an outer surface 18 of the golf ball 10 and includes a plurality of dimples 20 that are molded into the outer surface 18 to improve the aerodynamic flight of the golf ball 10. Each layer may be substantially concentric with every other layer such that every layer shares a common spherical center 22. Additionally, the mass-distribution of each layer may be uniform such that the center of mass for each layer and the ball as a whole is coincident with the common spherical center 22.

FIG. 2 schematically illustrates the golf ball 10 of FIG. 1 being struck by a golf club 30. As can be generally seen, the golf ball 10 will locally compress at the point of impact (generally at 32), before elastically returning to its original state. The magnitude of the compression/deformation is a function of the impact energy, the mass of the ball, and the compliance of the materials used to form the ball.

In general, the golf ball 10 may be formed through one or more injection molding or compression molding steps. For example, in one configuration, the fabrication of a multi-layer golf ball 10 may include: forming a core 12 through injection molding; compression molding one or more cold formed or partially-cured intermediate layers 14, about the core 12; and forming a cover layer 18 about the intermediate layer 14 through injection molding or compression molding.

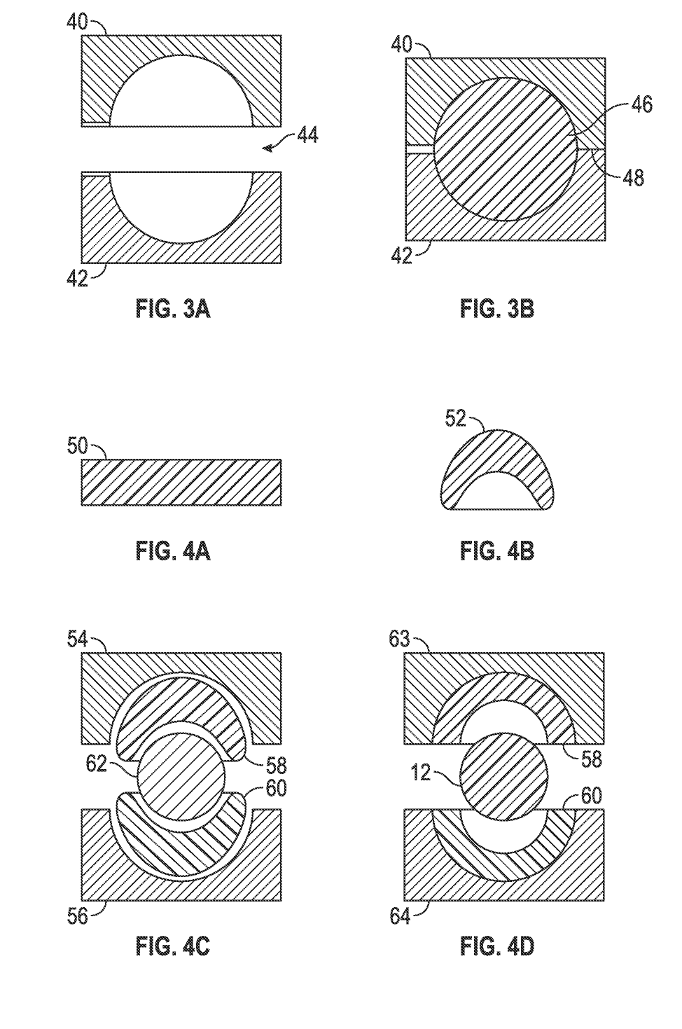

As schematically illustrated in FIGS. 3A & 3B, during the injection molding process used to form the core 12, two hemispherical dies 40, 42 may cooperate to form a mold cavity 44 that may be filled with a thermoplastic material 46 in a softened/molten state. The hemispherical molding dies 40, 42 may meet at a parting line 48 that, in one configuration, may be aligned along a plane of symmetry of the core 12. In one configuration, a thermoplastic ionomer may be used to form the core 12, such as one that may have a Vicat softening temperature, measured according to ASTM D1525, of between about 50° C. and about 60° C., or between about 52° C. and about 55° C. Suitable thermoplastic ionomeric materials are commercially available, for example, from the E.I. du Pont de Nemours and Company under the tradename Surlyn® or HPF.

Once the material 46 is cooled to ambient temperature, it may harden and be removed from the molding dies. Following removal from the dies, any molding flash may be removed using any combination of cutting, grinding, sanding, tumbling with an abrasive media, and/or cryogenic deflashing.

After any surface coatings are applied or preparations are performed to the core 12 (if any), the intermediate layer 14 may then be formed around the core 12, for example, through either a compression molding process or a subsequent injection molding process. During compression molding, two cold formed and/or pre-cured hemispherical blanks may be press-fit around the core 12. Once positioned, a suitable die may apply heat and/or pressure to the exterior of the blanks to cure/crosslink the blanks while fusing them together. During the curing process, the application of heat may cause the hemispherical blanks to initially soften and/or melt prior to the start of any crosslinking. The applied pressure may then cause the molten material to conform to the outer surface of the core 12. The curing process may be accelerated and/or initiated when as the material temperature approaches or exceeds about 200° C. In one configuration, the intermediate layer 14 may be formed from a rubber material, which may include a main rubber (e.g., a polybutadiene), an unsaturated carboxylic acid or metal salt thereof, and an organic peroxide.

FIGS. 4A-4D further illustrate an embodiment of a process that may be used to compression mold an intermediate layer 14 about the core 12. As shown in FIG. 4A, the intermediate layer may begin as piece of rubber stock 50 that may include one or more crosslinking agents and/or fillers that may be homogeneously or heterogeneously mixed throughout the stock 50. The stock 50 may be cold-formed into a substantially hemispherical blank 52 (shown in FIG. 4B) through one or more cutting, stamping, or pressing processes.

As schematically shown in FIG. 4C, two compression molding dies 54, 56 may form a pair of opposing blanks 58, 60 about a spherical metal core 62. At this stage, the blanks 58, 60 may be either cold-formed or partially cured through the application of heat so that they may retain a true hemispherical shape (within applicable tolerances). Finally, as shown in FIG. 4D, the spherical metal core 62 may be replaced by the thermoplastic core 12, and the blanks 58, 60 may be compression molded a second time by a second pair of opposing molding dies 63, 64 (which may or may not be the same dies 54, 66 used in the prior step). During this stage, the dies 63, 64 may apply a sufficient amount of heat and pressure to cause the blanks 58, 60 to flow within the mold cavity, and both internally crosslink and fuse to each other. Once set, the intermediate ball (i.e., the joined core 12 and intermediate layer 14) may be removed from the mold.

The cover 16 may generally surround the one or more intermediate layers 14, and may define the outermost surface of the ball 10. The cover 16 may generally be formed from a thermoplastic or thermoset material, such as, for example, a thermoplastic or thermoset polyurethane that may have a flexural modulus of up to about 1000 psi. In other embodiments, the cover 16 may be formed from an ionomer resin, in particular, a metal cation ionomer of an additional copolymer of an alpha olefin and an ethylenically unsaturated acid such as those commercially available from the E.I. du Pont de Nemours and Company under the tradename Surlyn®. When a thermoplastic polyurethane is used, the cover may have a hardness measured on the Shore-D hardness scale of, for example, up to about 65, measured on the ball. In other embodiments, the thermoplastic polyurethane cover may have a hardness measured on the Shore-D hardness scale of up to about 60, measured on the ball. If ionomers are used to form the cover layer, the cover may have a hardness measured on the Shore-D hardness scale of, for example, up to about 68 or up to about 72.

In a multi-piece or multi-layer ball design, such as described above, each layer may have the tendency to react differently to the stress imparted by an impact. In particular, due to the varying characteristics of the materials used, the stress/strain response of the ball may be non-uniform/non-linear across the ball, particularly at the boundaries between different materials. These non-uniformities may result in the occurrence of stress concentration points during an impact, which, over time, may degrade the performance of the golf ball 10.

In addition to causing stress concentration points, the existence of discrete material boundaries may also result in non-uniform stress propagation during the impact. That is, during an impact, forces imparted to the ball may initially be localized at the point of impact 32. Over a short period of time (e.g., less than 500 μs), these stresses may propagate throughout the ball, where they are eventually converted into other forms of energy and/or dissipated. This stress propagation may be viewed as a pressure wave that induces one or more dynamic viscoelastic deformations, including vibrational modes, of the golf ball 10. The viscoelastic dissipation that dampens any acoustic waves may have an effect on the acoustic response of the ball to a player, and the viscoelastic responses to the impact stress may have an effect on the response of the ball during and after the impact.

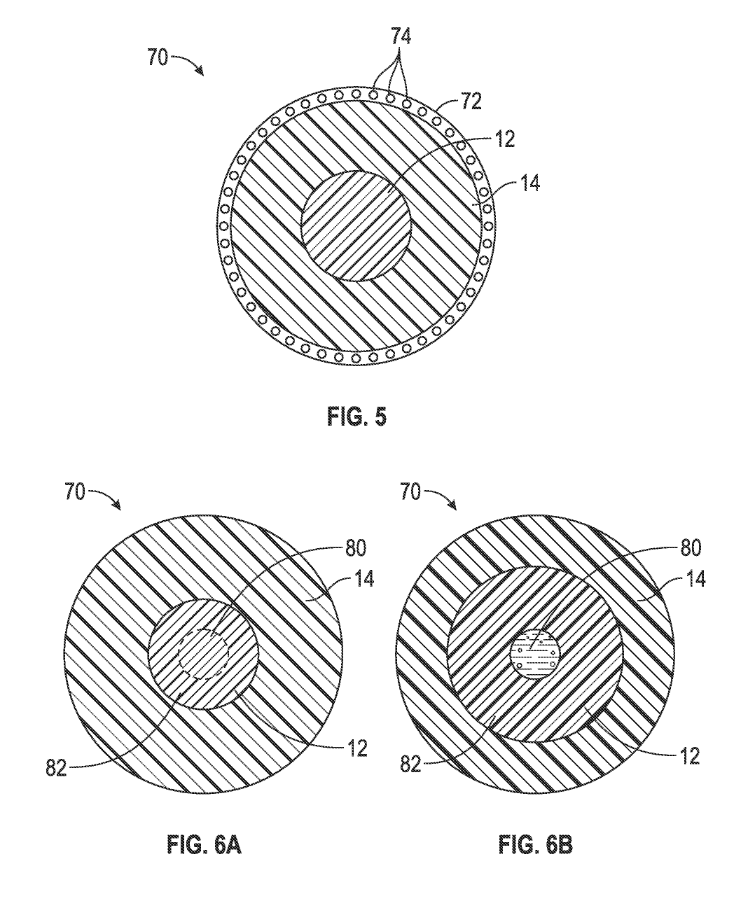

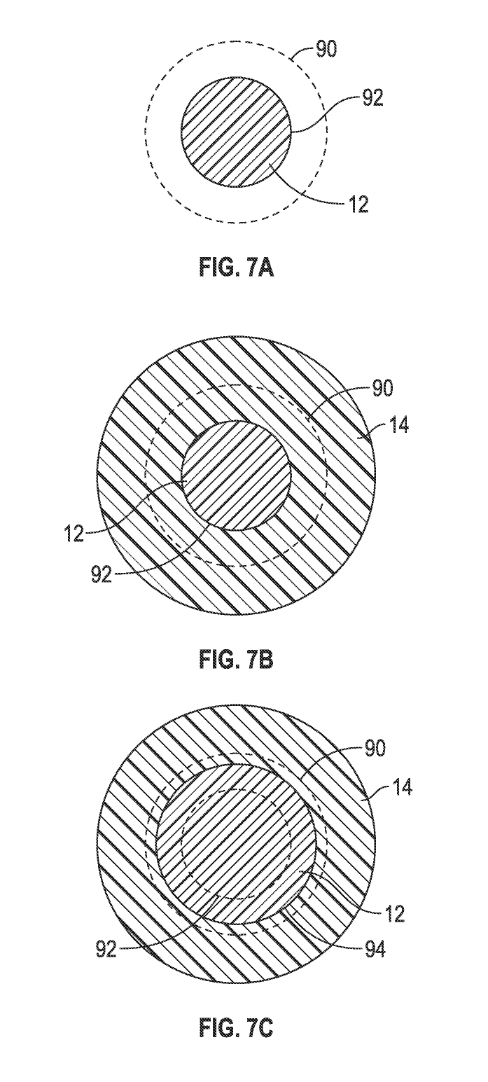

It has been found that by increasing the contact pressure between adjacent layers within the golf ball 10, the efficiency of the force transmission between the respective layers is increased, and the amount of energy that is dissipated at impact is correspondingly decreased. Three ways to increase the contact pressure between adjacent layers (e.g., an intermediate layer 14 and a core 12) include: applying a radially compressive force to the intermediate layer 14 prior to molding the cover 16 (as generally illustrated in FIG. 5); applying a radially expansive force to the core 12 after molding the cover 16 (as generally illustrated in FIGS. 6A and 6B); and over molding the intermediate layer 14 onto a volumetrically contracted core 12, and then allowing the core 12 to restore toward its original size (as generally illustrated in FIGS. 7A-7C). In each case, once formed, the core 12 and intermediate layer 14 may maintain a residual internal stress that promotes a positive contact pressure between the respective layers to allow impact stresses imparted by a golf club to more efficiently propagate throughout the ball.

FIG. 5 illustrates an intermediate ball 70 that includes a core 12, and an intermediate layer 14 disposed about the core 12. As generally discussed above, this intermediate ball 70 may be surrounded by a cover layer 16. While a core 12 and an intermediate layer 14 are shown for illustrative purposes, it should be understood that the described force-increasing techniques may be used to increase the contact pressure between any two adjacent layers in a multi-piece golf ball 10.

As shown in FIG. 5, a compression layer 72 is disposed radially outward from the intermediate layer 14 and is configured to apply a radially compressive force applied to the intermediate ball 70. This compressive force may mechanically constrict the intermediate layer 14 and core 12, while forcing the two layers into firm contact.

In one configuration, the compression layer 72 may include a webbing or winding formed from a fibrous, or wire-like material that may be tightly wrapped about the intermediate ball 70 (e.g., the compression layer 72 may include one or more elongate fibers 74 wound about the intermediate ball 70). The material used to form the compression layer 72 may be selected to have a tensile strength that is adequate to compress the intermediate ball 70 without breakage, while still having enough flexibility to receive repeated impact loadings without fatigue. Suitable materials may include, for example, a vulcanized natural rubber, isoprene rubber mixture, polybutadiene rubber, ionomer resins, poly (ether urethane urea) block copolymers, poly (ester urethane urea) block copolymers, polyester block copolymers, polyethylene, polyamide, poly(oxymethylene), polyether ether ketone, polyesters such as poly(ethylene terephthalate), polyamides such as poly(p-phenylene terephthalamide), poly(acrylonitrile), or natural fibers such as mineral fibers, or vegetable fibers; glass fiber, carbon fiber, or metal fiber.

In another embodiment, instead of being directly wrapped around the intermediate ball 70, the compression layer 72 may be pre-formed as a sleeve. The intermediate ball 70 may be inserted within the sleeve, and the sleeve may subsequently be drawn into firm, compressive contact with the intermediate layer 14. The sleeve may, for example, include a plurality of fibers 74 that may be drawn into contact with the intermediate ball 70 through a cinching action whereby a select few fibers within a woven pattern are tensioned to impart a constriction of the entire sleeve.

In another configuration, the sleeve may be constricted about the intermediate ball 70 through a molecular realignment or reorientation process that induces a dimensional change. For example, in one configuration, the sleeve may include one or more shape-memory alloy wires that are configured to dimensionally constrict upon a crystallographic phase change between an austenite phase and a martensite phase. In another embodiment, the sleeve may be formed from and/or include a uniaxially or biaxially oriented polyester (e.g., polyethylene terephthalate (PET)) or polyurethane composite material. Upon the application of heat, the highly oriented molecular structure may re-orient or dis-orient to contract about the intermediate ball 70.

FIGS. 6A and 6B schematically illustrate another embodiment where a radially expansive force may cause the core 12 to expand radially outward into forcible contact with the intermediate layer 14. As specifically shown, in one configuration, an inner portion 80 of the core 12 (i.e., “inner core” 80) may be configured to convert from a solid state (shown in FIG. 6A) into a liquid or gaseous state (shown in FIG. 6B) to cause a volumetric expansion and/or pressurization of the inner core 80.

In one configuration, this state change of the inner core 80 may occur, for example, through a chemical reaction that may generate a gaseous byproduct. This reaction may be initiated, for example, by the application of thermal energy to one or more reactants disposed within the inner core 80. In one configuration, the reaction may include a combination of an organic acid that has a melting point between about 80° C. and about 150° C. (e.g., sorbic acid), and sodium bicarbonate. Such a mixture would be dry at room temperature, however as the core is heated, the acid would melt and react with the bicarbonate, resulting in the generation of carbon dioxide. In such a design, the generated pressurized gasses may be contained by an outer portion 82 of the core 12 (i.e., “outer core 82) and/or by one or more gas barrier layers (not shown). A suitable gas barrier layer may be formed from, for example, an ethylene vinyl alcohol copolymer (EVOH) material. Once created, the pressurized gas would exert a radially outward pressure force against the outer core 82, which would urge the outer core 82 to expand against the intermediate layer 14. Examples of suitable reactants may include, but should not be limited to, azo blowing agents and/or peroxide blowing agents.

In another configuration, instead of a chemical reaction, the inner core 80 may undergo a phase change that causes it to volumetrically expand and exert an outward pressure. This phase change may be designed to substantially occur after the outer core 82 and/or the intermediate layer 14 are formed and hardened. In this embodiment, the inner core 80 may be formed from a material that is either a liquid, gel, or gas at ambient temperature (i.e. about 23° Celsius). Prior to the formation of the outer core 82 and/or the intermediate layer 14, the inner core 80 may be cooled below its crystallization temperature to cause it to solidify/crystallize and volumetrically contract. Following the molding of the outer core 82 and/or the intermediate layer 14, the temperature may increase, and the phase may return to its original state (at ambient temperature), and volumetrically expand.

In a configuration that relies on a phase change of the inner core 80 to exert an outward pressure, the inner core 80 may be formed from a material that changes state at a temperature from about −40° C. to about 0° C., or from about −20° C. to about −10° C. It is desirable to adjust the composition/crystallization temperature of the inner core material so that the material can withstand typical environmental conditions where golf is played, without freezing. In one configuration, the inner core 80 may be formed from a low molecular weight compound, a non-crosslinked or partially-crosslinked polymer, a water soluble polymer gel, or a water diffusible polymer gel.

A ball with a thermally expanding inner core 80 may be formed by initially encapsulating the desired inner core material in a mold of the desired inner core shape. This mold and contained liquid core material may be cooled to a temperature that is below the freezing point of the material, which would cause the material to solidify/crystallize. In one embodiment, the material may be cooled more than 100° C. below the freezing point. For example, the material may be cooled using liquid nitrogen. Immediately following the cooling, the outer core 82 may be molded about the frozen inner core 80, with the intermediate layer then molded about the outer core 82. Cooling the inner core 80 considerably below its freezing point provides additional time for the subsequent molding processes to be performed prior to full melting of the inner core 80.

While the above thermal cooling methods are described with respect to an inner core 80, in another embodiment, the outer core 82 may be omitted, and the intermediate layer 14 may be directly disposed about the inner core 80 (i.e., where the entire core 12 is formed from the frozen/crystallized material that is a liquid at ambient temperatures).

In yet another configuration, instead of relying on a phase change, an initial contraction of the core 12 may solely be imparted by thermal contraction within a single phase. As is commonly understood, within a given phase, a material will expand as it is heated, and contract as it is cooled (according to its coefficient of thermal expansion). In this manner, the core 12 may be cooled to a temperature below ambient (i.e., about 23° Celsius) prior to being over-molded with the intermediate layer 14. As the core 12 warms, it will naturally expand, and thus impart a contact pressure at the interface between the respective materials. In one configuration, the core 12 may be cooled to a temperature of from about −210° C. to about −100° C., which may occur through standard refrigeration, or, for example, through cryogenic cooling (e.g., submersion in liquid nitrogen).

FIGS. 7A, 7B, and 7C schematically illustrate the process of imparting an outward pressure against the intermediate layer 14 through an initial contraction of the core 12. As shown in FIG. 7A, a core 12 may initially be formed into a desired shape through at least one of injection molding (including injecting a material that exists as a liquid or gel at 23° C.), compression molding, thermoforming, or another suitable process. Once formed, the core 12 may be artificially contracted from its initial state 90 (denoted by the phantom line) to a contracted state 92 that is radially smaller than the initial state 90. As discussed above, this contraction may occur through a solidification/phase change, through thermal cooling within a single phase, or may occur through the application of an external force (e.g., using one or more compression pins, or externally applied magnetic forces).

Once contracted (and restrained in the contracted state 92), the intermediate layer 14 may be molded about the contracted core 12, as generally shown in FIG. 7B. Once the intermediate layer is sufficiently hard (either via cooling if it is a thermoplastic, or via curing/cross-linking if it is a thermoset), the core 12 may be allowed to expand to an intermediate state 94, as shown in FIG. 7C. This expansion may occur, for example, by allowing the core 12 to warm to room temperature either passively, or through the application of heat (e.g., water bath, autoclave, etc). As it expands, the core 12 may apply a contact pressure against the intermediate layer 14, which may be balanced by internal stresses within the intermediate layer 14.

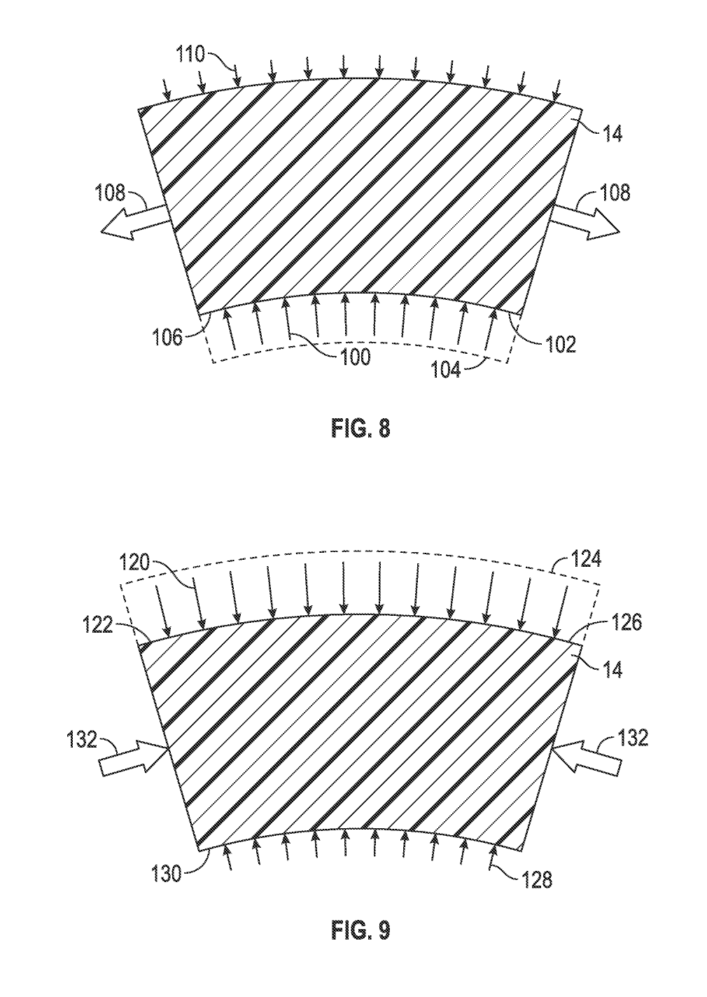

FIG. 8 generally illustrates a free body diagram of a section of the intermediate layer 14 provided in FIGS. 6B and/or 7C. When the core 12 radially expands, it will exert a pressure force 100 against an inner surface 102 of the intermediate layer 14. This pressure force 100 will cause the intermediate layer 14 to radially compress from a first, relaxed state 104 to a second, compressed state 106. As may be appreciated, the relaxed state of the intermediate layer 104 may correspond with the compressed state 92 of the core 12, while the compressed state 106 of the intermediate layer may correspond with the intermediate state 94 of the core 12. The radially outward pressure 100 applied to the intermediate layer 14 may be balanced by a hoop stress 108 within the intermediate layer 14, together with any contact pressure forces 110 that may be applied by the cover 16.

FIG. 9 generally illustrates a free body diagram of a section of the intermediate layer 14 provided in FIG. 5. In this embodiment, the compression layer 72 may apply a radially inward pressure 120 to the outer surface 122 of the intermediate layer 14. This pressure force 120 will cause the outer surface 122 of the intermediate layer 14 to radially compress from a first, relaxed state 124 to a second, compressed state 126. The forces applied to the outer surface 122 may be balanced by a contact pressure 128 applied to the radially inner surface 130 of the intermediate layer 14 (by the core 12) together with a compression force 132 applied through the layer 14.

As generally illustrated in both FIGS. 8 and 9, in each case, the intermediate layer 14 is elastically compressed in a radial direction. This radial compression is not attributable to standard molding processes (i.e., pressure normally applied through compression molding or injection molding), but rather is attributable to ancillary pressure forces (such as the forces attributable to the wound compression layer 72, the creation of pressurized inner-core gasses 84, and/or induced thermal expansion). This restrained elastic deformation will result in residual stresses applied through the various layers that would not ordinarily be present.

While the molding techniques described above are illustrative of the present techniques, additional or alternative injection molding and/or compression molding techniques may be used, such as those disclosed in U.S. Patent Publication No. US 2011/0319191 to Fitchett, filed on Jun. 24, 2010 and entitled “Golf Ball with Precompressed Medial Layer,” or those disclosed in U.S. patent application Ser. No. 13/935,953, filed on Jul. 5, 2013 to Ishii et al. and entitled “Multi-layer Golf Ball,” which is hereby incorporated by reference in its entirety.

Additionally, while a spherical core 12 is generally depicted in the above referenced figures, The core 12 may textured or contoured such as generally disclosed in U.S. patent application Ser. No. 13/935,953 to Ishii et al., or such as generally disclosed in U.S. patent application Ser. No. 13/935,977, filed on Jul. 5, 2013 to Ishii et al. and entitled “Multi-layer Golf Ball,” which is hereby incorporated by reference in its entirety, or in U.S. patent application Ser. No. 13/935,944, filed on Jul. 5, 2013 to Ishii et al. and entitled “Multi-layer Golf Ball,” which is hereby incorporated by reference in its entirety. Finally, the material composition of the various layers of the golf ball 10 may include the material types disclosed in Ser. No. 13/935,953 to Ishii et al.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting. Moreover, the referenced figures are not necessarily drawn to scale, and relative sizes should neither be inferred nor implied.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. In this description of the invention, for convenience, “polymer” and “resin” are used interchangeably to encompass resins, oligomers, and polymers. The terms “comprises,” “comprising,” “including,” and “having,” are inclusive and therefore specify the presence of stated items, but do not preclude the presence of other items. As used in this specification, the term “or” includes any and all combinations of one or more of the listed items. In other words, “or” means “and/or.” When the terms first, second, third, etc. are used to differentiate various items from each other, these designations are merely for convenience and do not limit the items.

1. A method of forming a golf ball comprising:
forming a golf ball core through at least one of injection molding and compression molding;
volumetrically contracting the golf ball core;
molding an intermediate layer about the volumetrically contracted core;
expanding the volumetrically contracted core to an intermediate state such that the core applies a contact pressure against an inner surface of the intermediate layer.

2. The method of claim 1, wherein the intermediate layer includes a residual internal stress attributable to the expansion of the golf ball core.

3. The method of claim 2, wherein the residual internal stress includes a tensile hoop stress, and a compressive radial stress.

4. The method of claim 1, wherein the expansion of the golf ball core radially compresses the intermediate layer.

5. The method of claim 1, wherein volumetrically contracting the golf ball core includes cooling the core to a temperature that is below 0° C.

6. The method of claim 5, wherein volumetrically contracting the golf ball core includes cooling the core to a temperature of from about −250° C. to about −100° C.

7. The method of claim 1, wherein volumetrically contracting the golf ball core includes applying a compressive force to the core through a plurality of compression pins.

8. The method of claim 1, further comprising molding a cover about the intermediate layer.

9. The method of claim 1, wherein forming a golf ball core through at least one of injection molding and compression molding includes injecting a material into a mold, wherein the material has a crystallization temperature of from about −40° C. to about −10° C.; and
wherein volumetrically contracting the golf ball core includes cooling the golf ball core to a temperature below its crystallization temperature.

10. A golf ball comprising:
a golf ball core having an outer surface;
an intermediate layer disposed about the golf ball core such that an inner surface of the intermediate layer is in contact with the outer surface of the golf ball core;
a cover disposed about the intermediate layer;
wherein the intermediate layer includes a radially compressive stress across the entire intermediate layer;
wherein the intermediate layer includes a tangential hoop stress across the entire intermediate layer; and
wherein there is a positive contact pressure between the outer surface of the golf ball core and the inner surface of the intermediate layer.

11. The golf ball of claim 10, wherein the radial compressive stress, the tangential hoop stress, and the positive contact pressure are induced by an expansion of the golf ball core following the molding of the intermediate layer.

12. The golf ball of claim 10, further comprising a compression layer disposed between the intermediate layer and the cover;
wherein the compression layer is configured to apply the radially compressive stress to the intermediate layer.

13. The golf ball of claim 12, wherein the compression layer includes a fibrous material wound about the intermediate layer under tension.

14. The golf ball of claim 12, wherein the compression layer includes a biaxially oriented polymer that is configured to disorient to apply a radially compressive stress to the intermediate layer.

15. The golf ball of claim 10, wherein the golf ball core includes a material that has a crystallization temperature of from about −40° C. to about −10° C.

16. The golf ball of claim 10, wherein the golf ball core is at least one of a liquid or a gel at 23° C.

17. The golf ball of claim 10, wherein the golf ball core includes at least one of an azo blowing agent and a hydro-peroxide blowing agent.
